(19) United States
(12) Patent Application Publication
(10) Pub. No.: US 2025/0113041 A1
(43) Pub. Date: Apr. 3, 2025

(54) Object-Specific Copresence Quality Tiers

(71) Applicant: Apple Inc., Cupertino, CA (US)

(72) Inventors: Jay Mayur Khandhar, Milpitas, CA (US); Borna Ghavam, San Francisco, CA (US); Kristian D. Pereira, San Jose, CA (US)

(21) Appl. No.: 18/817,898

(22) Filed: Aug. 28, 2024

Related U.S. Application Data
(60) Provisional application No. 63/586,695, filed on Sep. 29, 2023.

(51) Int. Cl. H04N 19/147; H04N 19/124; H04N 19/152

(52) U.S. Cl. CPC H04N 19/147; H04N 19/124; H04N 19/152

(57) ABSTRACT

A technique for managing transmission quality for objects in a copresence session includes obtaining representation data for a virtual representation of a subject. A first bitrate and a second bitrate are determined, where the first bitrate satisfies a first quality metric for a first data quality tier, and the second bitrate satisfies a second quality metric for a second quality tier. A set of data quality tiers are generated for the representation of the subject based on the first bitrate and the second bitrate.

### FIELD OF THE INVENTION

This disclosure relates generally to image processing. More particularly, but not by way of limitation, this disclosure relates to techniques and systems for improving encoding and transmission of avatar data.

### BACKGROUND

Some devices are capable of generating and presenting extended reality (XR) environments. An XR environment may include a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. Some XR environments allow multiple users to interact with each other within the XR environment. However, transmitting such avatar data can be computationally expensive.

### BRIEF DESCRIPTION OF THE DRAWINGS

FIGS. 1A-1B show example flow diagrams of a technique for encoding persona data, according to one or more embodiments.

FIG. 2 shows a flowchart of a technique for selectively transmitting different qualities of persona data, according to one or more embodiments.

FIG. 3 shows, a diagram of a technique to selectively request different qualities of persona data, in accordance with one or more embodiments.

FIG. 4 shows a flowchart of a technique for determining a region of interest, according to one or more embodiments.

FIG. 5 shows, in block diagram form, an example network diagram, according to one or more embodiments.

FIG. 6 shows, in block diagram form, a mobile device in accordance with one or more embodiments.

### DETAILED DESCRIPTION

Embodiments described herein relate to a technique for generating and transmitting persona data. In particular, embodiments described herein described technique for determining custom quality tiers for objects for which data is transmitted in a copresence environment in order to optimize bandwidth allocation.

Techniques described herein relate to a method, system, and computer readable medium for efficiently representing persona data by selectively transmitting data at a particular quality level that is specific to an object represented in the transmission. In particular, a user's characteristics can affect resources required to generate associated persona data. For example, a bitrate required to encode persona data for a first person encoded by a particular encoder may differ from a bitrate required to encode persona data for a second person encoded by the same encoder. This may be the case, for example, based on a difference in physical characteristics, movement characteristics, or other differences between the two people or objects which require different bitrates in order to fully, or substantially, encode the data.

Generally, techniques described herein are directed to encoding persona data at different quality levels using different encoder parameters, for example using encoders associated with different quantization parameter values. Upon encoding the persona data, a target bitrate can be determined at which all of the persona data, or a substantial portion of the persona data, is fully encoded. For example, outliers may be excluded, or a threshold amount of the data may be considered. The encoder parameters, such as the target bitrate, can then be used for the associated quality tier level.

According to some embodiments, this process can be performed for multiple encoders having different quantization parameters, or a single encoder using different quality levels. The resulting bitrates can then be used the determine encoder parameters for personalized quality tiers for the object captured in the encoded data.

The data used to determine the quality tiers may be captured during an enrollment process, according to some embodiments. To that end, a user may be prompted to perform predefined movements, expressions, speech, or the like, in order to generate some underlying persona data which can be used during runtime while the user is in a copresence experience. Some or all of this data can be used to determine the user-specific data quality tiers. In some embodiments, the tiers may be determined during runtime, or may be adjusted during runtime based on additional sensor data captured during a copresence experience, or during later enrollment processes.

Techniques described herein are associated with various technical improvements. For example, techniques described herein reduce the total data being transmitted to the receiving device by optimizing transmission parameters allocated to each user. Because a virtual communication session may include numerous users, the technical improvements are multiplied. For example, overall bandwidth requirements are reduced by reducing the quality of the data transmission for some or all of the devices.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, it being necessary to resort to the claims in order to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not necessarily be understood as all referring to the same embodiment.

It will be appreciated that, in the development of any actual implementation (as in any software and/or hardware development project), numerous decisions must be made to achieve a developer's specific goals (e.g., compliance with system- and business-related constraints) and that these goals may vary from one implementation to another. It will also be appreciated that such development efforts might be complex and time consuming but would nevertheless be a routine undertaking for those of ordinary skill in the design and implementation of multi-modal processing systems having the benefit of this disclosure.

Various examples of electronic systems and techniques for using such systems in relation to various technologies are described.

A physical environment, as used herein, refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust the characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

For purposes of the following disclosure, the term “copresence environment” refers to a virtual environment presented by a client device which includes representations of one or more additional users accessing the virtual environment from a separate device. The copresence environment may additionally or alternatively include one or more representations of a physical object which is visible to one or more users in the copresence experience.

For purposes of the following disclosure, the term “copresence session” refers to a communication session between two or more devices within a copresence environment.

For purposes of this application, the term “persona” refers to a virtual representation of a subject that is generated to accurately reflect the subject's physical characteristics, movements, and the like.

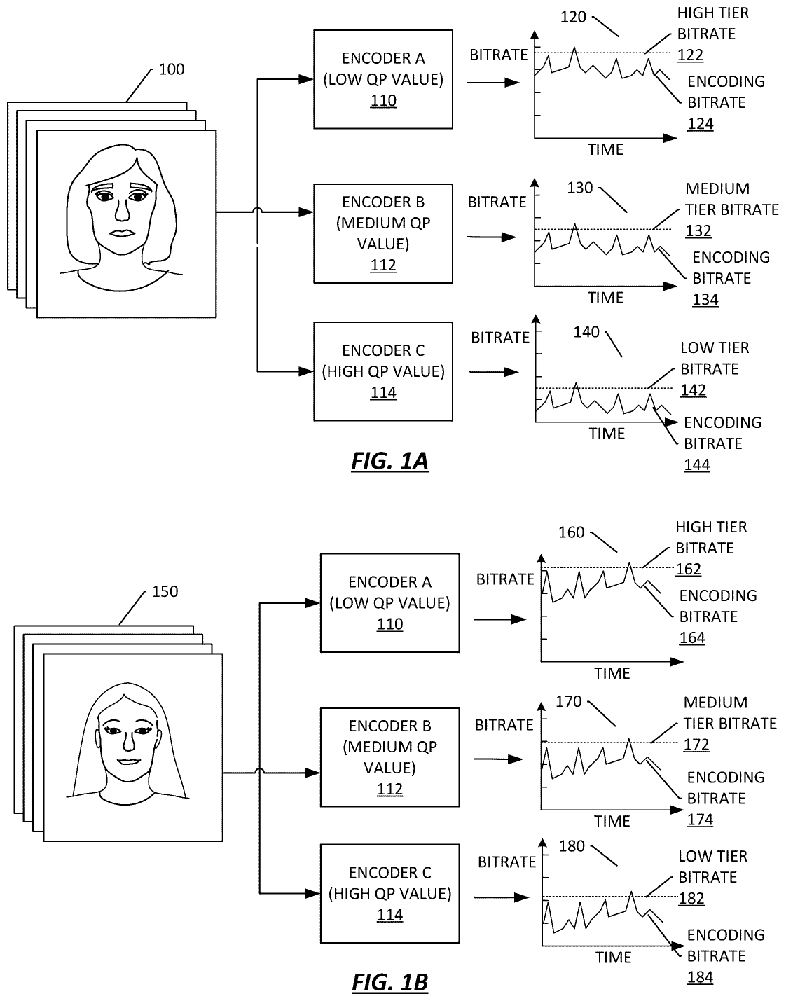

FIGS. 1A-1B show example flow diagrams of a technique for encoding persona data, according to one or more embodiments. It should be understood that the exact components and flow presented within FIGS. 1A-1B is presented for example purposes only and is not particularly intended to limit the claims.

Turning to FIG. 1A, persona data 100 is captured of a subject over a series of frames. Here, the subject is a first person. The persona data 100 may include, for example, image data, depth data, audio data, and the like. The persona data 100 may include representations of the user derived from captured sensor data, such as 3D geometric information, texture information, feature vectors, and the like. Further, the persona data 100 may include a single frame or multiple frames, such as a series of frames. In some embodiments, the persona data 100 may be captured during an enrollment process, such as while a user is preparing to use a particular device for use in a copresence experience. In some embodiments, the persona data may alternatively, or additionally, be captured during the copresence experience.

The persona data 100 may be encoded at different quality levels. As shown in FIG. 1A, the persona data 100 may be encoded by different encoders associated with different quantization parameter values. Encoder A 110 is associated with a low quantization parameter value, while encoder B 112 is associated with a medium quantization parameter value, and encoder C 114 is associated with a low quantization parameter value. The quantization parameter value indicates an amount of compression performed on a set of data. As such, a low quantization parameter value indicates a small level of compression (and, thus, higher data quality level) as compared to a high quantization parameter value, which indicates more compression (and, thus, a low data quality level). For purposes of FIGS. 1A-1B, the different quality levels correspond to encoders having different quantization parameter (QP) values. However, in alternative embodiments, different techniques or parameters can be used to determine the different quality levels of the encodings.

In FIG. 1A, the result of persona data 100 being encoded by encoder A 110 (having a low QP value). The resulting encoding may require different bitrates over time. For example, chart 120 depicts a representation of the encoding bitrate 124 required over time to encode the frames of persona data 100 using encoder A 110. This may occur, for example based on the characteristics of the object depicted in a particular frame, changes in characteristics of the object over a set of frames, or the like. According to one or more embodiments, a target high tier bitrate 122 may be determined based on the bitrate over time. The target high tier bitrate 122 may correspond to a bitrate at which a sufficient amount of persona data is able to be encoded. As such, the target high tier bitrate may be a bitrate at which the entirety of the persona data 100 can be encoded using a particular set of encoder parameters. As another example, as shown by high tier bitrate 122, the target bitrate may be selected by ignoring outliers of data frames. For example, the target bitrate may be selected based on a bit rate at which a threshold amount of persona data is able to be encoded using a particular set of encoder parameters. In this example, high tier bitrate 122 indicates a bitrate at which a sufficient amount of the persona data 100 can be encoded using a low QP value. This high tier bitrate 122 is specific to the object, such as the user depicted in persona data 100. As such, a different object's persona data may result in a different target bitrate for a same encoding quality, as will be described below with respect to FIG. 1B.

Similarly, the technique for determining a target bitrate can be repeated for other tier levels. For example, chart 130 depicts a representation of the encoding bitrate 134 required over the set of frames to encode the persona data 100 using encoder B 112, which may be associated with different encoder parameters than encoder A 110. According to one or more embodiments, a target medium tier bitrate 132 may be determined based on the bitrate over time using the particular encoder parameters. As such, the target medium tier bitrate 132 may be a bitrate at which the entirety of the persona data 100 can be transmitted based on the medium quality encoding, for example using medium quality encoder parameters. As another example, as shown by medium tier bitrate 132, the target bitrate may be selected by ignoring outliers of data frames. For example, the target bitrate may be selected based on a bit rate at which a threshold amount of persona data is able to be encoded. In this example, medium tier bitrate 132 indicates a bitrate at which a sufficient amount of the persona data 100 can be encoded using a medium QP value, or other encoder parameters associated with a medium quality. This medium tier bitrate 132 is again specific to the object, such as the user depicted in persona data 100.

The same technique is applied for a low-quality encoding of the persona data. For example, chart 140 depicts a representation of the encoding bitrate 144 required over time to encode the persona data 100 using encoder C 114. According to one or more embodiments, a target low tier bitrate 142 may be determined based on the bitrate over time. As such, the target low tier bitrate 142 may be a bitrate at which the entirety of the persona data 100 can be encoded based on the low quality encoding, for example using low quality encoder parameters. As another example, as shown by low tier bitrate 142, the target bitrate may be selected by ignoring outliers of data frames. For example, the target bitrate may be selected based on a bit rate at which a threshold amount of persona data is able to be encoded. In this example, low tier bitrate 142 indicates a bitrate at which a sufficient amount of the persona data 100 can be transmitted when the persona data 100 is encoded using a high QP value or other high quality encoder parameters. This low tier bitrate 142 is again specific to the object, such as the user depicted in persona data 100.

Turning to FIG. 1B it becomes clear that the different target bandwidth values may differ across users. As shown, persona data 150 is captured of a different subject over a series of frames. Here, the subject is a second person, different than the first person. However, it should be understood that the subject may be any object, person, animal, or the like, for which data (i.e., persona data) is collected and transmitted for providing a visual and/or audio representation of the subject at a remote device. As such, the persona data 150 may include, for example, image data, depth data, geometry data, texture data, audio data, and the like. The persona data 150 may include representations of the user derived from captured sensor data, such as 3D geometric information, texture information, feature vectors, and the like. Further, the persona data 150 may include a single frame or multiple frames, such as a series of frames. In some embodiments, the persona data 150 may be captured during an enrollment process, such as while a user is preparing to use a particular device for use in a copresence experience. In some embodiments, the persona data may alternatively, or additionally, be captured during the copresence experience. According to one or more embodiments, the particular type or amount of data may differ from one subject to another. For example, persona data collected on one device may differ in size, quality, or the like, based on persona data collected on another device.

In FIG. 1B, the persona data 150 may be encoded by different encoders associated with different quantization parameter values. The encoders may be the same or different than those described above with respect to FIG. 1A. That is, different subjects may use different encoders for determining data quality tiers associated with different encoder parameters. For purposes of this example, the persona data 150 is encoded using the same encoders as those used for persona data 100, although the encoders may be located on different devices. Encoder A 110 is associated with a first set of encoder parameters, such as a low quantization parameter value, while encoder B 112 is associated with a second set of encoder parameters, such as a medium quantization parameter value, and encoder C 114 is associated with a third set of encoder parameters, such as a a high quantization parameter value. The persona data 150 may be encoded by the different encoders in response to receiving the persona data, such as during the enrollment process. Additionally, or alternatively, the persona data may be encoded in the background, such as when a user is using the device but is not actively using the persona data, or at other times while the device is active.

The persona data 150 will have different characteristics than the persona data 100 because of the different subjects, devices capturing the data, or the like. As a result, bitrates required to encode the persona data 150 at each quality level may differ from the bitrates required to encode the persona data 100 at the same quality levels. For example, chart 160 depicts a representation of the bitrate required over time to encode the frames of persona data 150 using encoder A 110. The encoding bitrate 164 changes over time. This may occur, for example based on the characteristics of the object depicted in a particular frame, changes in characteristics of the object over a set of frames, or the like. The target high tier bitrate 162 may correspond to a bitrate at which a sufficient amount of persona data is able to be encoded and transmitted during a copresence session. As such, the target high tier bitrate may be a bitrate at which the entirety of the persona data 150, or a predefined amount of the persona data (for example, ignoring outliers) can be transmitted based on the encoding. This high tier bitrate 162 is specific to the object, such as the user depicted in persona data 150. As a result, the high tier bitrate 162 may differ from high tier bitrate 122 determined for the subject presented in persona data 100.

Similarly, the technique for determining a target bitrate can be repeated for other tier levels for the persona data 150. For example, chart 170 depicts a representation of the encoding bitrate 174 required over time to encode the persona data 150 using encoder B 112 for a medium QP value. In this example, medium tier bitrate 172 indicates a bitrate at which a sufficient amount of the persona data 150 can be encoded using a medium QP value. This medium tier bitrate 172 is again specific to the object, such as the user depicted in persona data 150, and may thereby differ from medium tier bitrate 132 determined for persona data 100 using encoder B 112.

The technique is also used in this example for a low tier bitrate (associated with a high QP value). For example, chart 180 depicts a representation of the encoding bitrate 184 required over time to encode the persona data 150 using encoder C 114 for a high QP value. In this example, low tier bitrate 182 indicates a bitrate at which a sufficient amount of the persona data 150 can be transmitted when the persona data 150 is encoded using a high QP value. This low tier bitrate 182 is again specific to the object, such as the user depicted in persona data 150, and may thereby differ from low tier bitrate 142 determined for persona data 100 using encoder C 114.

In addition to the bitrates for each tier being unique to a particular subject, a range or interval between tiers may differ for each subject. That is, a delta in bitrate between high tier bitrate 122 and medium tier bitrate 132 for persona data 100 may differ from a delta between high tier bitrate 162 and medium tier bitrate 172. Similarly, a delta in bitrate between medium tier bitrate 132 and low tier bitrate 142 for persona data 100 may differ from a delta between medium tier bitrate 172 and low tier bitrate 182.

The subject-specific quality tiers can be used when the subject is participating in a copresence environment. For example, if a subject in persona data 100 and the subject in persona data 150 are participating in a copresence environment, their associated devices may publish or otherwise make known their object-specific quality tiers such that other devices active in the copresence session can subscribe to a particular copresence quality tier for a given user. For example, a device can determine a quality tier from which to receive persona data from one or more other devices in a copresence session. The particular tier may be the same for all devices, or may differ. That is, a device may subscribe to a high quality tier transmission associated with a high tier bitrate for one user, and may subscribe to a medium quality tier transmission associated with a medium tier bitrate for a second user.

According to one or more embodiments, the tier selection for different users may be based on a number of factors. For example, the selection may be based on a bandwidth policy with indicates how bandwidth should be allocated, resource availability, user-selection, or the like. Further, in some embodiments, the selection may be performed at a central system communicably connected to the devices in the copresence session.

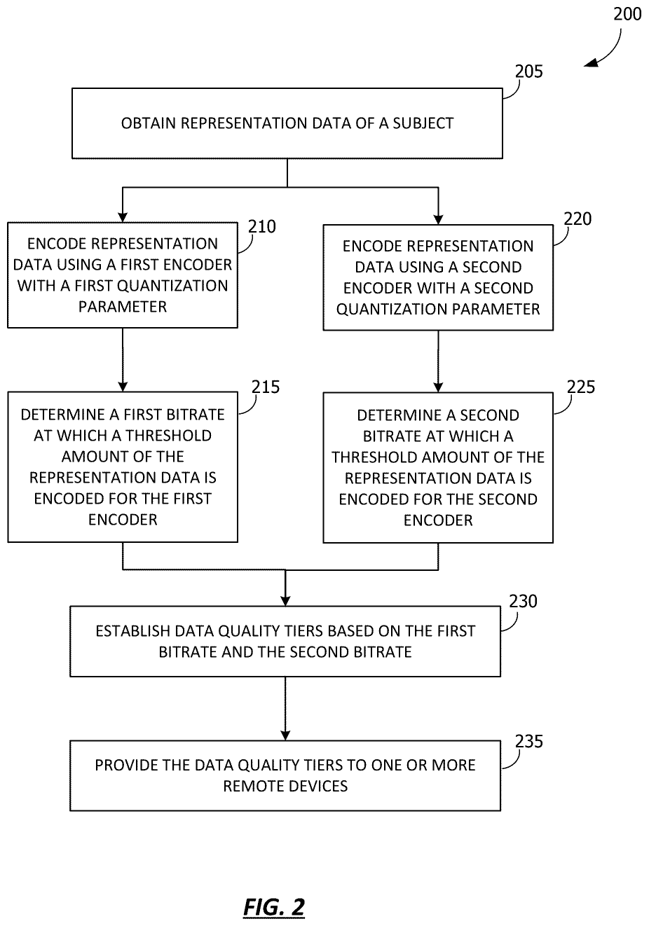

FIG. 2 shows a flowchart of a technique for establishing object-specific data quality tiers based on sensor data of a particular object. For purposes of explanation, the following steps will be described in the context of particular components. However, it should be understood that the various actions may be taken by alternate components. In addition, the various actions may be performed in a different order. Further, some actions may be performed simultaneously, and those depicted as being performed simultaneously may be performed in a different order, or the like. In addition, some processes presented may not be required, or others may be added, according to various embodiments.

The flowchart 200 begins at block 205, where representation data of the subject is obtained. In some embodiments, the representation data of the subject may include sensor data captured by the subject. This representation data may include image data, audio data, or the like, and may be captured during an enrollment stage, and/or during runtime. Further, in some embodiments, prior-captured sensor data or representation data may be used for performing the various processes. That is, the representation data may be captured prior to a device's participation in a copresence session, during participation in the copresence session, or the like.

In some embodiments, the representation data may correspond to persona data for a user. In some embodiments, in order for a user to utilize a persona in a copresence environment, user may navigate through an enrollment process on a particular device, which includes capturing sensor data of the user from one or more angles, and performing one or more expressions, or the like. The sensor data captured may thus include depth data, image data, audio data, and the like. Further, in some embodiments, the representation data used for establishing a quality tiers may be derived from the sensor data. For example, the representation data may include geometric data, texture data, video data, audio data, or the like which is derived from the sensor data captured of the subject.

Although the examples provided in FIG. 1 describe the techniques being performed on persona data collected for different users, in some embodiments, the subject for which representation data is obtained may not be a user, or may not even be a person. That is, in some embodiments, the techniques described herein provide functionality for improving transmittal of data representing the object. As such, the subject could be associated with any virtual or physical object for which representation data is transmitted to other devices for presentation of the representation of the subject.

The flowchart 200 continues at block 210, where the representation data is encoded using a first encoder associated with a first quantization parameter. The encoder may be a computational module which is configured to compress the representation data for transmission. The encoder may be associated with a quantization parameter indicative of an amount of compression applied to the data being encoded. Then, at block 215, the first bitrate is determined at which a threshold amount of the representation data is encoded by the first encoder. According to one or more embodiments, the threshold amount of representation data may include an entirety of the representation data, a predefined portion of the representation data, or the like. In some embodiments, the bitrate may be determined on a frame-by-frame basis, and the bitrate values which are outliers among the full data set may be discarded. Further, other techniques may be deployed to determine a first bitrate by reducing outliers and noise in the bitrate calculation for the encoding of the representation data.

Returning to block 220, the representation data will additionally be encoded using a second encoder with a second quantization parameter. In some embodiments, the second quantization parameter will be different than the first quantization parameter. In some embodiments, the first encoder and the second encoder may be a single encoder operating in different modes, and thereby operating with different quantization parameters. As such, the first encoder refers herein to a computational module encoding data at a first level compression, whereas the second encoder refers to a same or different computational module encoding data at a second level of compression. According to one or more embodiments, the representation data may be encoded using the first encoder and second encoder simultaneously, or may be encoded by the first encoder and the second encoder at different times. At block 225, a second bitrate is determined at which a threshold amount of the representation data is encoded for the second encoder. According to one or more embodiments, the threshold amount of representation data may include an entirety of the representation data, a predefined portion of the representation data, or the like. In some embodiments, the bit rate may be determined on a frame-by-frame basis, and the great values which are outliers among the full data set may be discarded. Further, other techniques may be deployed to determine a first bit rate while reducing outliers and noise in the bit rate calculation for the encoding of the representation data.

The flowchart 200 continues at block 230, where data quality teachers are established for the subject based on the first bitrate and the second bitrate. The data quality tiers thereby indicate bitrates associated with particular quality levels and are specific to the subject. That is, the data quality tiers for the particular subject include the first bitrate for a quality level associated with the first quantization parameter, and a second bitrate for a quality level associated with the second quantization parameter. It should be understood that the process described above with respect to block 210-225 can be repeated for any given number of encoders and/or quality tiers.

The flowchart 200 concludes at block 235, where the data quality tiers are provided to one or more remote devices. In some embodiments, data quality tiers may be provided to one or more devices during a copresence session with the subject. In some embodiments, the data quality tiers may be specific to the subject on a particular device (for example, the device or system comprising a first encoder and 2nd encoder). In this instance, the data quality tiers for the subject are associated with the particular device having the first encoder and a 2nd encoder. In some embodiments, the data quality tiers are advertised to other users in a copresence environment participate in a copresence session such that each user can negotiate bandwidth allocation to the different devices participating in the copresence session. In some embodiments, the data quality tiers may be provided to a management device which acts as a centralized module for negotiating resources such as bandwidth among different devices in a copresence session. Each device participating in the copresence session may provide unique quality or information, and may provide a different number of tiers. Furthermore, in the device may participate in the copresence session without providing data quality tier information, or providing alternative data quality information, such as a ceiling or floor bitrate level for a subject using the device.

According to one or more embodiments, the data quality tiers may be revised when additional data is received for a particular object. For example, in some embodiments, a person may repeat an enrollment process, thereby generating additional persona data from which the set of data quality tiers can be determined. As another example, during a copresence communication session, additional persona data which is captured and encoded can be used to refine the object specific data quality tiers.

As described above, in some embodiments, the representation data can be captured during an enrollment stage. To that end, a user may be prompted to perform predefined movements, expressions, speech, or the like, in order to generate some underlying persona data which can be used during runtime while the user is in a copresence experience. Some or all of this data can be used to determine the user-specific data quality tiers.

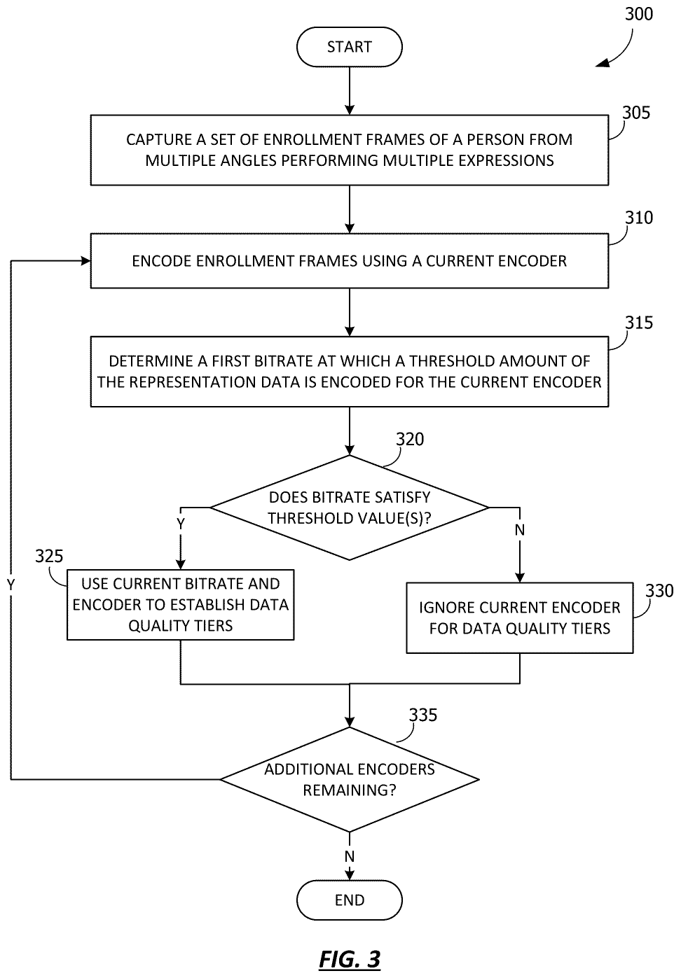

FIG. 3 depicts a flowchart of a technique for determining target bitrates for one or more data quality tiers to ensure the bitrate satisfies one or more threshold values. For purposes of explanation, the following steps will be described in the context of particular components. However, it should be understood that the various actions may be taken by alternate components. In addition, the various actions may be performed in a different order. Further, some actions may be performed simultaneously, and those depicted as being performed simultaneously may be performed in a different order, or the like. In addition, some processes presented may not be required, or others may be added, according to various embodiments.

The flowchart 300 begins at block 305, where a set of enrollment frames are captured of a person from multiple angles and performing multiple expressions. In some embodiments, sensor data is captured through this process to generate persona data which can be used in a copresence communication session to generate a representation of the user based on the user's movements, visual characteristics, audio characteristics, and/or the like. The enrollment frames may include image data, audio data, or the like. Further, the enrollment frames a include representation data of the person derived from the sensor data. For example, the enrollment frames may include geometric information of the person's face, texture information for the person, and the like. The set of frames may be captured by sensors on a client device used by the person captured in the enrollment data, such as a head mounted device, mobile device, or the like. Further, in some embodiments, the enrollment frames may be captured at a device separate from a client device to be used in the copresence session. For example, a user may participate in the enrollment process as a desktop computer or other device. According to some embodiments, a single user may be associated with multiple sets of object-specific data quality tiers which are determine from different devices. As an example, a person's persona data collected on a desktop device may require different bitrates than persona data collected on a remote device. As such, a singe object (such as the person) may be associated with multiple alternative sets of object specific data quality tiers.

The flowchart 300 continues at block 310, where the enrollment frames are encoded using a current encoder. According to some embodiments, different encoders may be assisted with different quality levels, and the settlement frames may be encoded by each of these encoders to determine target bit rates for various quality levels. In some embodiments, a single encoder may be used in multiple modes corresponding to different quality levels. That is, the set of enrollment frames may be processed by an encoder to compress the enrollment frames based on a quantization parameter associated with the encoder. The encoder may be a computational module which is configured to compress the representation data for transmission. The encoder may be associated with a quantization parameter indicative of an amount of compression applied to the data being encoded. Then, at block 315, a bitrate is determined at which a threshold amount of the data in the enrollment frames is encoded by the current encoder. According to one or more embodiments, the threshold amount of representation data may include an entirety of the representation data, a predefined portion of the representation data, or the like. In some embodiments, the bitrate may be determined on a frame-by-frame basis, and the bitrate values which are outliers among the full data set may be discarded. Further, other techniques may be deployed to determine a first bitrate by reducing outliers and noise in the bitrate calculation for the encoding of the representation data.

At block 320, a determination is made as to whether the bitrate satisfies one or more quality metrics. According to one or more embodiments, one or more metrics may be predefined which provide minimum or maximum values which the bit rate should satisfy in order to be assigned to a data quality tier level. For example, in some embodiments, a device may identify a minimum threshold quantization parameter that a particular encoder or device can use. As a result, a ceiling can be put on the maximum bit rate that can be set for an object specific data quality tier. If a determination is made at block 320 that the bit rate satisfies the quality metrics, then the flowchart proceeds to block 325, and the current rate and encoder are used to establish the data quality tiers.

By contrast, if the bitrate does not satisfy the quality metrics at block 320, then the flowchart proceeds to block 330. At block 330, the current encoder is ignored for the data quality tiers. As described above, the encoder may be a particular encoder of a set of encoders, or may be a single encoder which has encoded the enrollment frames using a particular quality level at block 310. The bitrate may not satisfy the quality metric, for example, if a target bitrate for the encoder exceeds a maximum bitrate allowed. In this situation, the particular quantization parameter for the encoder will not be made available for the subject. As such, the current encoder (or encoder mode) will not be used for contributing to the data quality tiers for the person in the enrollment frames.

The flowchart 300 proceeds to block 335, where a determination is made as to whether additional encoded domain. In some embodiments, the process described above with respect to block 310-335 can be repeated for any given number of encoders and/or quality tiers. The resulting object-specific data quality tiers will then be specific to the user, and may differ from one person to another. Further, the enrollment data is leveraged for performing the determination such that the determination does not need to be performed during runtime, thereby preserving resources while the current device is participating in a copresence session.

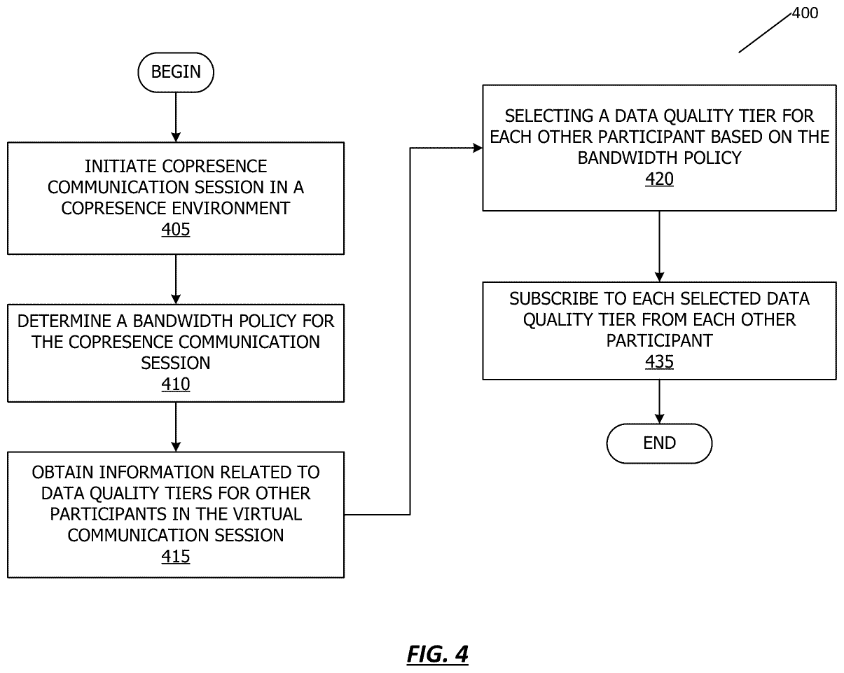

According to one or more embodiments, the techniques described herein can be used to allocate available bandwidth during a copresence session. In some embodiments, the allocation may be performed at each device participating in the copresence communication session. FIG. 4 depicts a flowchart of a technique for a particular client device subscribing to data quality tiers for other devices participating in the copresence session. For purposes of explanation, the following steps will be described in the context of particular components. However, it should be understood that the various actions may be taken by alternate components. In addition, the various actions may be performed in a different order. Further, some actions may be performed simultaneously, in a different order, or the like. In addition, some processes presented may not be required, or others may be added, according to various embodiments.

The flowchart 400 begins at block 405, where a virtual communication session is initiated in a copresence environment. According or more embodiments, the copresence communication session may include two or more devices sharing a virtual environment. In some embodiments, the users of the different devices may be represented in the environment as personas. Further, other objects may be represented in the copresence environment to each of the users based on a representation data for the object. As such, the copresence environment may include a mix of representations of the virtual and physical objects which are visible to each device participating in the virtual communication session.

The flowchart 400 continues to block 410, where a bandwidth policy is determined for the copresence communication session. According to one or more embodiments, the bandwidth policy may be a global bandwidth policy, may be a device specific bandwidth policy, or the like. Further, the bandwidth policy may be determined automatically, or may be at least partially user defined. The bandwidth policy may indicate or provide parameters for allocating available bandwidth and/or other resources among devices with which the local device is communicating in the copresence communication session. For example, the bandwidth policy may indicate how bandwidth should be allocated based on available bandwidth or other bandwidth conditions. Additionally, or alternatively, other metrics may be used for determining how bandwidth should be allocated. For example, data received from some devices or users may be prioritized, and allocated more bandwidth than other devices or users. Similarly, if other objects are providing data streams, users may be allocated more or less bandwidth than other physical or virtual objects present in the copresence environment. For example, in particular object is determined to be of particular importance, a data stream associate with the object may be allocated more bandwidth than other participants in the copresence environment.

At block 415, information is obtained related to the data quality tiers for other participants in the copresence communication session. The information related to the data quality tiers may be obtained by each participant, such as a remote user or other objects providing representation data, publishing their object specific data quality tiers. Alternatively, a network device or other centralized management device may obtain the data quality tier information from each device and provide consolidated data quality or information for participants in the copresence communication session. In some embodiments, as a device joins a copresence communication session, the device can advertise the device's user's object specific data quality tiers such that the other devices in the copresence session can determine a bitrate for transmission with the newly joined device. The flowchart 400 continues to block 420, where data quality tier is selected for each of the other participants based on the bandwidth policy. According to one or more embodiments, the selection may be performed at each participant device, or may be selected by a central management device, or by an additional device connected to the participant devices in the copresence environment.

The flowchart 400 concludes at block 435, where the local device subscribes to the selected data quality tiers from the other participants. For example, a local device can send a request for transition and in particular the quality level to another device in the copresence environment based on the selection. In some embodiments, the description may be part of the handshake process enabling transmission between two devices in the copresence communication session. According to some embodiments, each device may subscribe to different data quality tiers for different devices. As an example, a particular device may provide representation data, such as persona data for a user collected during the copresence communication session at a first quality level to a first remote device, and a second quality level to a second remote device. Further, as described above, even if a device were to subscribe to a same quality tier from multiple of the remote devices, the target bandwidth associated with each of those devices may differ. As such, device can more effectively allocate bandwidth among the other participants based on a measured target bitrate that is specific to that device/user and, thus, optimizes bandwidth usage by limiting the bandwidth that is allocated but not used.

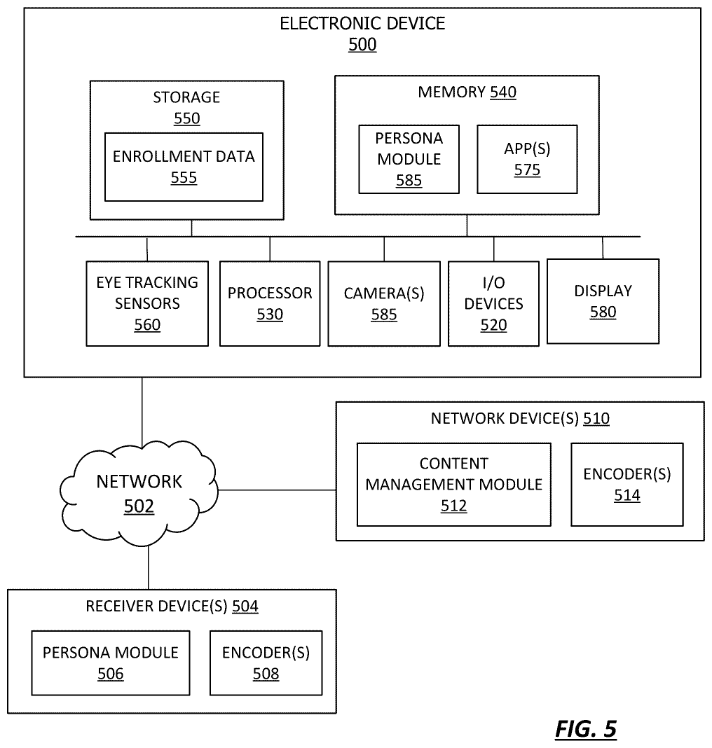

FIG. 5 depicts a network diagram for a system by which various embodiments of the disclosure may be practiced. Specifically, FIG. 5 depicts an electronic device 500 that is a computer system having XR capabilities. Electronic device 500 may be part of a multifunctional device, such as a mobile phone, tablet computer, personal digital assistant, portable music/video player, wearable device, head-mounted system, projection-based system, base station, laptop computer, desktop computer, network device, or any other electronic system such as those described herein. Electronic device 500 may be connected to other devices across a network 502 such as receiver device 504, and/or accessory electronic devices, mobile devices, tablet devices, desktop devices, or remote sensing devices.

Referring to FIG. 5, a simplified block diagram of an electronic device 500 is depicted, communicably connected to a one or more additional electronic device(s) such as receiver device 504, in accordance with one or more embodiments of the disclosure. Electronic device 500 and receiver device 504 may each be part of a multifunctional device, such as a mobile phone, tablet computer, personal digital assistant, portable music/video player, wearable device, base station, laptop computer, desktop computer, network device, or any other electronic device. Electronic device 500 may be connected to one or more additional receiver device 504 and one or more network device(s) 510 across a network 502. Illustrative networks include, but are not limited to, a local network such as a universal serial bus (USB) network, an organization's local area network, and a wide area network such as the Internet. According to one or more embodiments, electronic device 500 and the one or more additional electronic device(s) 504 may participate in a communication session in which each device may render a persona of a user of the other client device.

Each of electronic device 500 may include a processor, such as a central processing unit (CPU) 530. Processor 530 may be a system-on-chip such as those found in mobile devices and include one or more dedicated graphics processing units (GPUs). Further, processor 530 may include multiple processors of the same or different type. Electronic device 500 may also include a memory, such as memory 540. Each memory may include one or more different types of memory, which may be used for performing device functions in conjunction with one or more processors, such as processor 530. For example, each memory may include cache, ROM, RAM, or any kind of transitory or non-transitory computer-readable storage medium capable of storing computer-readable code. Each memory may store various programming modules for execution by processors, including persona module 585 and/or other application(s) 575. Electronic device 500 may also include storage, such as storage 550. Each storage may include one more non-transitory computer-readable mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage may include data for use in generating personas and participating in a copresence environment, including enrollment data 555. Enrollment data 555 may be used to determine eye tracking data or the like. Further, enrollment data 555 may be used to generate persona data for a user of the electronic device 500.

Electronic device 500 may also include one or more cameras, such as cameras 585, or other sensors, such as eye tracking sensor 560. In one or more embodiments, each of the one or more cameras 585 may be a traditional RGB camera, depth camera, infrared camera, or the like. Further, each of the one or more cameras 585 may include a stereo- or other multi-camera system, a time-of-flight camera system, or the like which capture images from which depth information of a scene may be determined. Each of electronic device 500 and additional electronic device(s) device 504 may allow a user to interact with extended reality (XR) environments. There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display devices 580 and 508 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Additional electronic device(s) 504 may include components which enable the devices to generate persona data or other shared content in a copresence environment. As such, additional electronic device(s) 504 may include a persona module 506 to generate persona data. In one or more embodiments, each of the additional electronic device(s) may include one or more encoder(s) which can encode one or more data streams of persona data or other content to be shared with the copresence environment. In some embodiments, a single encoder can be used to generate and transmit data streams at different quality levels. In some embodiments, the additional electronic device(s) may include encoders associated with different quality levels, such as different quantization parameters.

The one or more network device(s) 510 may include, for example, a content management module 512 which manages data stream requests from receiver devices in the copresence session. The content management module 512 can retrieve the correct data stream for a given sender device and, if necessary, reduce the data stream prior to transmitting to the requesting device. In some embodiments, the network device(s) 510 may include one or more encoders 514 to package and transmit the requested data stream(s) to the requesting device(s).

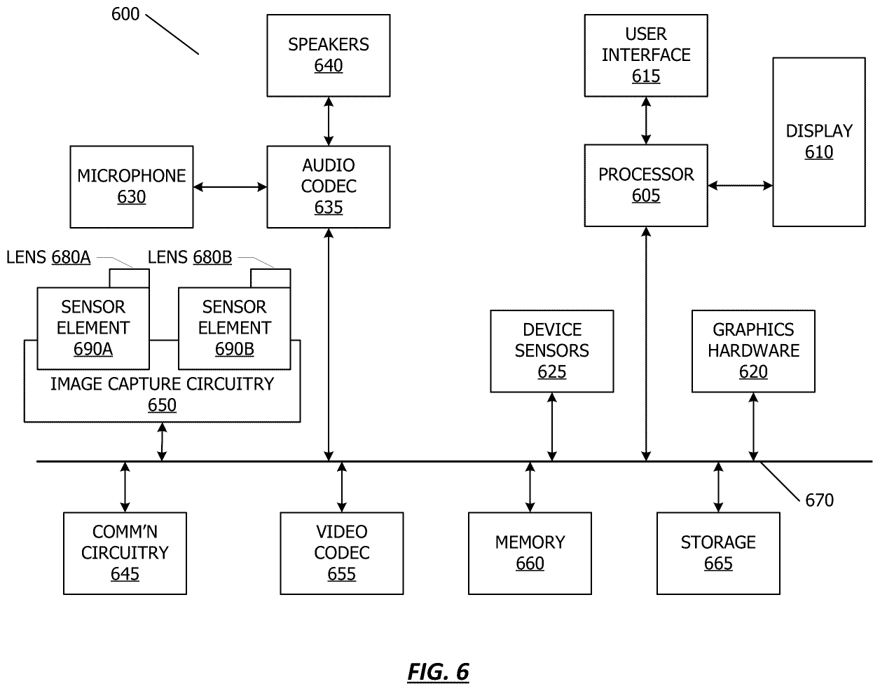

Referring now to FIG. 6, a simplified functional block diagram of illustrative multifunction electronic device 600 is shown according to one embodiment. The electronic device may be a multifunctional electronic device or may have some or all of the components of a multifunctional electronic device described herein. Multifunction electronic device 600 may include some combination of processor 605, display 610, user interface 615, graphics hardware 620, device sensors 625 (e.g., proximity sensor/ambient light sensor, accelerometer and/or gyroscope), microphone 630, audio codec 635, speaker(s) 640, communications circuitry 645, digital image capture circuitry 650 (e.g., including camera system), memory 660, storage device 665, and communications bus 670. Multifunction electronic device 600 may be, for example, a mobile telephone, personal music player, wearable device, tablet computer, or the like.

Processor 605 may execute instructions necessary to carry out or control the operation of many functions performed by device 600. Processor 605 may, for instance, drive display 610 and receive user input from user interface 615. User interface 615 may allow a user to interact with device 600. For example, user interface 615 can take a variety of forms, such as a button, keypad, dial, click wheel, keyboard, display screen, touch screen, and the like. Processor 605 may also, for example, be a system-on-chip, such as those found in mobile devices, and include a dedicated GPU. Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include one or more lens assemblies, such as lens 680A and 680B. The lens assembly may have a combination of various characteristics, such as differing focal length and the like. For example, lens assembly 680A may have a short focal length relative to the focal length of lens assembly 680B. Each lens assembly may have a separate associated sensor element 690A and 690B. Alternatively, two or more lens assemblies may share a common sensor element. Image capture circuitry 650 may capture still images, video images, enhanced images, and the like. Output from image capture circuitry 650 may be processed, at least in part, by video codec(s) 655, processor 605, graphics hardware 620, and/or a dedicated image processing unit or pipeline incorporated within communications circuitry 645. Images so captured may be stored in memory 660 and/or storage 665.

Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image, and video files), computer program instructions or software, preference information, device profile information, and any other suitable data. Storage 665 may include one more non-transitory computer-readable storage mediums, including, for example, magnetic disks (fixed, floppy, and removable) and tape, optical media such as CD-ROMs and DVDs, and semiconductor memory devices such as EPROM and EEPROM. Memory 660 and storage 665 may be used to tangibly retain computer program instructions or computer-readable code organized into one or more modules and written in any desired computer programming language. When executed by, for example, processor 605, such computer program code may implement one or more of the methods described herein.

The present technology may gather and use data from various sources to improve transmission of user. This data, in some instances, may include personal information data that uniquely identifies or may be used to locate or contact a specific individual. This personal information data may include location-based data, demographic data, telephone numbers, email addresses, social media account names, home or work addresses, data or records associated with a user's health or fitness level (e.g., information associated with vital signs, medication, exercise, and the like), date of birth, or other personal or identifying information.

In some instances, such personal information data may be used to benefit users. For example, the personal information data may be used to determine user-specific quality levels. Accordingly, use of such personal information data enables modulated control of bandwidth and other resources.

It is contemplated that the collection, disclosure, transfer, analysis, storage, or other use of personal information data should comply with well-established privacy policies or practices. Privacy policies and practices that are generally recognized as meeting or exceeding industry or governmental requirements for maintaining personal information data private and secure should be implemented and consistently used. These policies should be easily accessible and updated as the collection or use of the personal information data changes. Personal information data should be collected for legitimate and reasonable uses and not shared or sold outside of those legitimate uses. The collection or sharing should occur after receipt of the user's informed consent. Additional steps to safeguard and secure access to personal information data and to ensure that others with access to the personal information data adhere to their privacy policies and procedures should be considered. An evaluation by third parties to certify adherence to well-established privacy policies and practices may be performed. Policies and practices should be tailored to the particular types of personal information data being collected or accessed and adapted to applicable laws and standards, including jurisdiction-specific considerations. For example, the collection of or access to certain health data in the US may be governed by federal or state laws, such as the Health Insurance Portability and Accountability Act (HIPAA); whereas the collection of or access to the same health data may be subject to other regulations and policies in other countries. As such, different privacy practices should be implemented for different types of personal information data in each country.

It is contemplated that, in some instances, users may selectively prevent the use of, or access to, personal information data. Hardware or software features may be provided to prevent or block access to personal information data. For example, in the case of user-specific copresence quality levels, the present technology may be configured to allow users to “opt in” or “opt out” of the collection of personal information data during registration or anytime thereafter. In another example, users can select not to provide enrollment data for determining user-specific copresence quality levels. In yet another example, users can select to limit the length of time enrollment data is maintained or entirely prohibit the determination of user-specific copresence quality levels. The present technology may also provide notifications relating to the access or use of personal information data. For example, a first notification may be provided in response to a user downloading an app that may access the user's personal information data and a second notification may be provided to remind the user just before the app accesses the personal information data.

Personal information data should be managed and handled to reduce the risk of unintentional or unauthorized access or use. Risk can be reduced by limiting the collection of data and deleting the data once it is no longer needed. When applicable, data de-identification may be used to protect a user's privacy. For example, de-identification may be performed by removing specific identifiers, controlling the specificity or amount of data stored (e.g., collecting home location data at a city level instead of at an address level), controlling how data is stored (e.g., aggregate data across multiple users), or by using other techniques.

Although the present technology may broadly include the use of personal information data, it may be implemented without accessing such personal information data. In other words, the present technology may not be rendered inoperable due to the lack of some or all of such personal information data. For example, user-specific copresence quality levels may be based on non-personal information data, a reduced amount of personal information data, or publicly available information.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-4, or the arrangement of elements shown in FIGS. 1 and 5-6 should not be construed as limiting the scope of the disclosed subject matter. The scope of the invention, therefore, should be determined with reference to the appended claims, along with the full scope of equivalents to which such claims are entitled. In the appended claims, the terms “including” and “in which” are used as the plain English equivalents of the respective terms “comprising” and “wherein.”

1. A method comprising:
obtaining representation data for a virtual representation of a subject;
determining, based on the representation data, a first bitrate to satisfy a first quality metric for a first data quality tier;
determining, based on the representation data, a second bitrate to satisfy a second quality metric for a second data quality tier; and
generating a set of data quality tiers for the representation of the subject based on the first bitrate and the second bitrate.

2. The method of claim 1, wherein the representation data comprises persona data, and wherein the subject comprises a person.

3. The method of claim 1, further comprising transmitting additional representation data in accordance with the first data quality tier or the second data quality tier in accordance with a bandwidth policy.

4. The method of claim 1, further comprising transmitting data quality tier information for the representation data to one or more remote devices in a copresence communication session.

5. The method of claim 1, further comprising:
encoding the representation data using a first encoder for the first quality metric, and
identifying the first bitrate based on the encoding using the first encoder,
wherein determining the second bitrate comprises:
encoding the persona data using a second encoder for the second quality metric, and
identifying the second bitrate based on the encoding using the second encoder.

6. The method of claim 1, wherein the representation data comprises at least one selected from a group consisting of geometric data, texture data, video data, and audio data for at least one of the subject and a particular representation of the subject.

7. The method of claim 6, wherein the representation data is obtained during an enrollment process.

8. The method of claim 7, wherein the enrollment process is performed on a first device, and wherein additional representation data from an enrollment process on an additional device is associated with an alternative set of data quality tiers for an alternative representation of the subject.

9. A non-transitory computer readable medium comprising computer readable code executable by one or more processors to:
obtain persona data for a virtual representation of a person;
determine, based on the persona data, a first bitrate to satisfy a first quality metric for a first data quality tier;
determine, based on the persona data, a second bitrate to satisfy a second quality metric for a second data quality tier; and
generate a set of data quality tiers for the virtual representation of the person based on the first bitrate and the second bitrate.

10. The non-transitory computer readable medium of claim 9, further comprising computer readable code to:
transmit additional persona data in accordance with the first data quality tier or the second data quality tier in accordance with a bandwidth policy.

11. The non-transitory computer readable medium of claim 9, further comprising computer readable code to:
transmit quality tier information for the persona data to one or more remote devices in a copresence communication session.

12. The non-transitory computer readable medium of claim 9, wherein the persona data comprises at least one selected from a group consisting of geometric data, texture data, video data, and audio data for at least one of a user and a persona representation of the user.

13. The non-transitory computer readable medium of claim 9, wherein the computer readable code to determine the first bitrate comprises computer readable code to:
encode the persona data using a first encoder for the first quality metric, and
identify the first bitrate based on the encoding using the first encoder,
wherein the computer readable code to determine the second bitrate comprises computer readable code to:
encode the persona data using a second encoder for the second quality metric, and
identify the second bitrate based on the encoding using the second encoder.

14. The non-transitory computer readable medium of claim 13, wherein the computer readable code to identify the first bitrate based on the encoding using the first encoder comprises computer readable code to:
determine a bitrate at which a threshold amount of the persona data is encoded by the first encoder.

15. The non-transitory computer readable medium of claim 14, wherein the set of data quality tiers are modified during runtime based on additional persona data collected.

16. A system comprising:
one or more processors; and
one or more computer readable media comprising computer readable code executable by the one or more processors to:
obtain persona data for a virtual representation of a person;
determine, based on the persona data, a first bitrate to satisfy a first quality metric for a first data quality tier;
determine, based on the persona data, a second bitrate to satisfy a second quality metric for a second data quality tier; and
generate a set of data quality tiers for the virtual representation of the person based on the first bitrate and the second bitrate.

17. The system of claim 16, wherein the computer readable code to determine the first bitrate comprises computer readable code to:
encode the persona data using a first encoder for the first quality metric, and
identify the first bitrate based on the encoding using the first encoder,
wherein the computer readable code to determine the second bitrate comprises computer readable code to:
encode the persona data using a second encoder for the second quality metric, and
identify the second bitrate based on the encoding using the second encoder.

18. The system of claim 17, wherein the computer readable code to identify the first bitrate based on the encoding using the first encoder comprises computer readable code to:
determine a bitrate at which a threshold amount of the persona data is encoded by the first encoder.

19. The system of claim 17, wherein the computer readable code to identify the first bitrate based on the encoding using the first encoder comprises computer readable code to:
determine a bitrate that satisfies a threshold quantization parameter for the first encoder.

20. The system of claim 17, wherein the set of data quality tiers are modified during runtime based on additional persona data collected.
